(19) United States
(12) Patent Application Publication
(10) Pub. No.: US 2010/0253756 A1
(43) Pub. Date: Oct. 7, 2010

(54) Method of Ink Delayed Curing for UV Inkjet Printers

(76) Inventor: Chih-Hua YEH, Hsi Chih City (TW)

Correspondence Address: Muncy, Geissler, Olds & Lowe, PLLC, 4000 Legato Road, Suite 310, FAIRFAX, VA, 22033, US

(21) Appl. No.: 12/238,999

(22) Filed: Sep. 26, 2008

(51) Int. Cl. B41J 2/01

(52) U.S. Cl. 347/102

(57) ABSTRACT

A method of ink delayed curing for an UV inkjet printer, the method comprises the following steps: a. closing a pair of movable light-blocking plates on an UV lamp set of an inkjet module on UV inkjet printer; b. activating printing, forwarding the inkjet module toward a set direction and provide ink for a work piece; c. after the inkjet module provides ink toward the set direction, opening the movable light-blocking plates of an UV lamp set so that the UV lamp set can irradiate on the work piece; and d. making the inkjet module move back for its next inkjetting stage, thereby irradiation onto the ink on the work piece by the UV lamp set can be delayed till the inkjet module moves back.

### BACKGROUND OF THE INVENTION

1. Field of the Invention

The present invention relates a method of ink delayed curing for UV inkjet printers; and more particularly to a method of ink delayed curing by irradiating UV energy after ink's reflective surface increases. Thereby gloss of the ink can be increased to get an effect of having a bright even surface visually.

2. Description of the Prior Art

In the art of peripheral equipment of computers or printing, printers seem to be one of the necessary and basic outfits; inkjet printers, in addition to be used for printing general documents, home works, and reports with jetting colored inks of different concentrations and different inkjet cartridges following the advanced technique of color inkjet. Thereby, being able to generate colors desired, it is not a dream to use an inkjet printer to print out paper or several media in photo quality.

For the art of printing, development of inkjet products is a global tendency. Even for a tiny amount of products which are variant, one can get it in hand fast by printing with an inkjet printer to save time and habour than working with color-separated halftones. Thus, a firm gains superiority in its competitive business.

When printing through an UV inkjet printer, the inkjet printer is equipped with an UV lamp set providing curable ink to dry at outputting onto a piece of work. However, when the ink is cured instantly, its gloss is always inadequate over time and creates a problem of fogging effect. Therefore, it is in the beauty of art to find a method for providing both the functions of curing the ink and increasing the glossiness of output,

### SUMMARY OF THE INVENTION

The primary objective of this present invention is to provide a method of ink delayed curing for an UV inkjet printer, which increases glossiness of the ink and enhances the effect of having a bright, glossy even surface visually.

In order to achieve the objective of this present invention, the method of ink delayed curing for an UV inkjet printer comprises the following steps: a. Closing a pair of movable light-blocking plates; b. Activating a printing process with an inkjet module toward a set direction to provide ink for a work piece; c. Opening the movable light-blocking plates on an UV lamp set after the inkjet module provides ink toward the set direction so that an UV lamp set is ready to irradiate on the printed work piece; d. Commanding the inkjet module to return for its next inkjetting stage; thereby the UV on the inkjetted work piece procedure irradiates during the returning of the inkjet module while inkjets after previous UV irradiation.

The present invention will be apparent after reading the detailed description of the preferred embodiment thereof in reference to the accompanying drawings.

### BRIEF DESCRIPTION OF THE DRAWINGS

FIG. 1 is a flow chart showing the method of ink delayed curing of this present invention;

FIG. 2 is a perspective view showing the appearance of an inkjet module of this present invention;

FIG. 3 is a schematic view showing the state of inking supply of the inkjet module in the embodiment of the present invention;

FIG. 4 is a schematic view showing the state of irradiation from an UV lamp set in the embodiment of the present invention.

### DETAILED DESCRIPTION OF THE PREFERRED EMBODIMENT

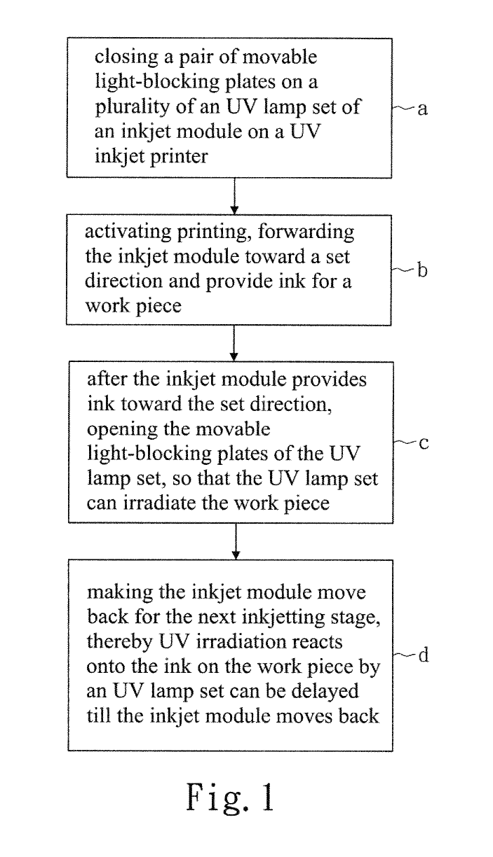

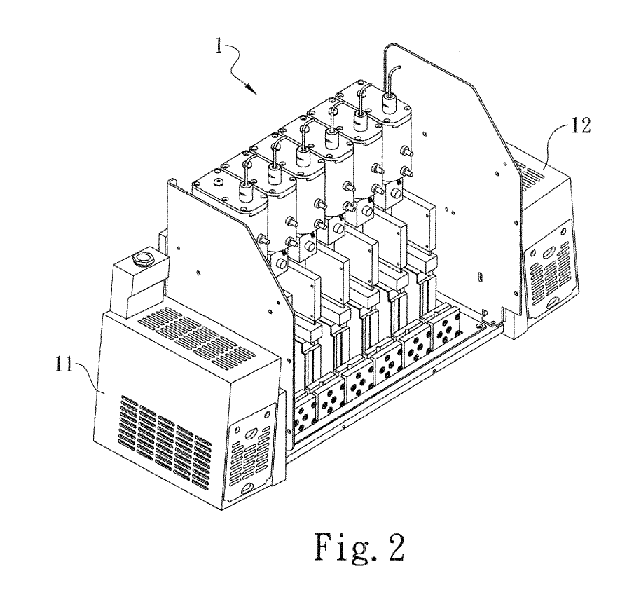

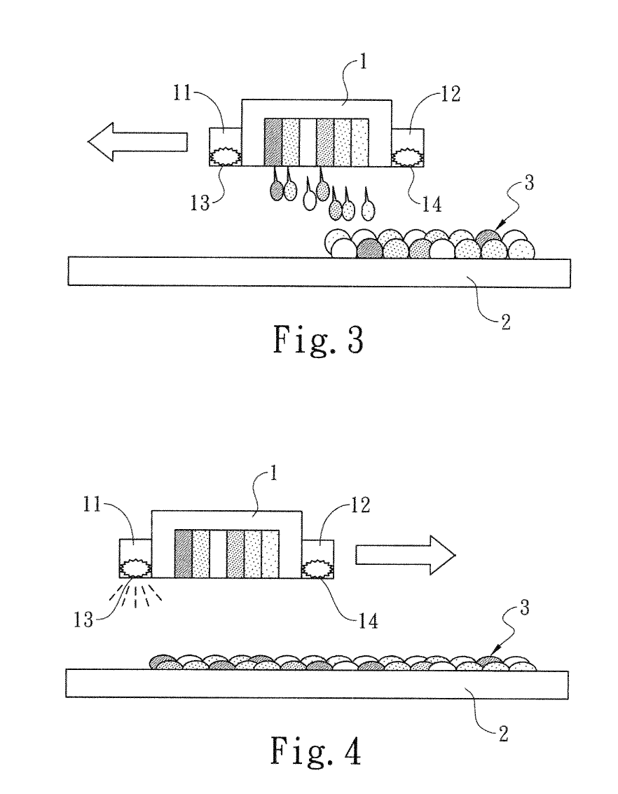

Referring firstly to FIGS. 1˜4 showing a preferred embodiment of the method of ink delayed curing for an UV inkjet printer of this present invention, the method comprises the following steps:

a. Closing the pair of movable light-blocking plates 14 on a UV lamp set 12, leaving the movable light-blocking plates 13 and UV lamp 11 of an inkjet module 1 on the UV inkjet printer open; b. Activating printing procedure, to forward the inkjet module 1 toward a set direction while inkjetting ink for a work piece 2;

c. After the inkjet module 1 inkjetting ink toward the set direction, the movable light-blocking plates 13 is open and the UV lamps 11 is on, so that the UV lamps 11 irradiates onto the work piece 2;

d. Commanding the inkjet module 1 moves back as a returning for the next inkjetting stage; thereby the UV irradiation reacts onto ink 3 on the work piece surface 2 with light-blocking plates 14 open and UV lamp 12 on causing ink 3 to be cured first, then the ink 3 gets jetted afterwards simultaneously.

Within this method, both the UV lamps 11, 12 are mounted to two lateral sides of the inkjet module 1. The Opening/Closing function of the movable light-blocking plates 13, 14 of the UV lamps 11, 12 are controlled by a computer controller (not shown). The UV lamps 11, 12 are turned on for illumination when 13, 14 are in open, Either 13 or 14 is set to close, UV irradiation will be light-blocked, providing no reaction to curable inks and vice versa.

In practicing, when the inkjet module 1 finishes forwarding toward the set direction to inkjetting ink to the work piece 2, the UV lamp 12 and the movable light-blocking plate 14 are controlled by the computer controller to open; now the ink 3 has gotten adequate time for being laid out flat before the inkjet module 1 moves back to cure. Hence, after the inkjet module 1 moves back to provide irradiation of the UV lamp 12, not only the object, in this case refers to the inkjetted ink dots, of curing can be achieved, but also the ink gloss will be enhanced by increasing reflective area after the ink 2 is laid out flat. And thereby an effect of having a brighter even surface can be obtained.

In conclusion, according to the description disclosed above, the present invention surely provides the expected object effect thereof to provide a method of ink delayed curing for any forms of UV inkjet printers. By increasing the area of ink flatness and reflection, the gloss of the inkjetted ink reveals an effect of having a brighter, true glossy, finishing work piece. The embodiment stated above is only for illustrating this present invention. It will be apparent to those skilled in this art that various equivalent modifications or changes according to the idea of and without departing from the spirit of this invention shall also fall within the scope of the appended claims.

1. A method of ink delayed curing for an UV inkjet printer comprising following steps:
a. closing a pair of movable light-blocking plates on an UV lamp including at least one UV lamp of an inkjet module on said UV inkjet printer;
b. activating printing procedure, to forward said inkjet module toward a set direction and provide ink for a work piece;
c. after said inkjet module provides ink toward said set direction, opening said movable light-blocking plates of said an UV lamp set, so that said UV lamps irradiate said work piece; and
d. making said inkjet module moves back for its next inkjetting stage, thereby irradiation onto said ink on said work piece by said UV lamps is delayed till said inkjet module moves back.

2. The method of ink delayed curing for an UV inkjet printer as in claim 1, wherein: said UV lamps are provided at two lateral sides of said inkjet module.

3. The method of ink delayed curing for an UV inkjet printer as in claim 1, wherein: opening/closing of said movable light-blocking plates of said UV lamps are controlled by a computer controller.

4. The method of ink delayed curing for an UV inkjet printer as in claim 1, wherein: said UV lamps are turned on for illumination when in opening of said movable light-blocking plates.
